(19) United States
(12) Patent Application Publication
(10) Pub. No.: US 2014/0346908 A1
(43) Pub. Date: Nov. 27, 2014

(54) ELECTRIC MACHINE COMPRISING A DEFORMABLE STATOR

(71) Applicant: SIEMENS AKTIENGESELLSCHAFT, Munchen (DE)

(72) Inventor: ANDERS JAKOB MADSEN, HERNING (DK)

(73) Assignee: SIEMENS AKTIENGESELLSCHAFT, Munchen (DE)

(21) Appl. No.: 14/269,583

(22) Filed: May 5, 2014

(30) Foreign Application Priority Data
May 23, 2013 (EP) 13168847.5

(51) Int. Cl. H02K 21/02; H02K 21/22

(52) U.S. Cl. CPC H02K 21/025; H02K 21/22
USPC 310/90

(57) ABSTRACT

An electric machine, in particular a generator for a wind turbine, is provided. The electric machine has a rotor and a stator, wherein the rotor is arranged rotatably relative to the stator about an axis of rotation. The rotor and the stator are arranged in such a way that a stator surface of the stator and a rotor surface of the rotor are spaced apart from one another. The rotor surface is circular about the axis of rotation. The stator is deformable in such a way that the stator surface has a non-circular surface profile about the axis of rotation without any magnetic interactions between the rotor and the stator being exerted within at least one segment of the stator, and that, in the event that magnetic interactions between the rotor and the stator are exerted, the stator is deformed in such a way that the stator surface is circular about the axis of rotation, with the result that a spacing between the stator surface and the rotor surface is constant.

### CROSS-REFERENCE TO RELATED APPLICATIONS

This application claims priority to EP Application No. 13168847.5, having a filing date of May 23, 2013, the entire contents of which are hereby incorporated by reference.

### FIELD OF TECHNOLOGY

The following relates to an electric machine, in particular a generator for a wind turbine, and to a method for producing the electric machine or the generator for the wind turbine.

### BACKGROUND

An electric machine such as, for example, a generator for a wind turbine comprises a rotor and a stator, wherein the rotor rotates relative to the stator. For wind turbines, a generator which has an external rotor, which surrounds an internal stator, is commonly used. High levels of magnetic interaction prevail between the rotor and the stator. In particular in the case of the stator, this can mean that, during operation of the generator, the stator is deformed and its surface profile deviates from a circular shape. In other words, the gap between the circular rotor and the stator may be inconstant in the circumferential direction and can vary to a significant extent depending on the level of local magnetic interactions. This inconstancy of the gap between the rotor and the stator impairs the efficiency of the electric machine or of the generator.

### SUMMARY

An aspect relates to providing an electric machine which has high efficiency.

This aspect is achieved by an electric machine, in particular by a generator for a wind turbine, and by a method for producing an electric machine, in particular for producing a generator for a wind turbine.

In accordance with a first aspect of described embodiments, an electric machine, in particular a generator for a wind turbine, is provided. The electric machine has a rotor and a stator. The rotor is arranged rotatably relative to the stator about an axis of rotation. The rotor and the stator are arranged in such a way that a stator surface of the stator and a rotor surface of the rotor are spaced apart from one another. The rotor surface is circular in the circumferential direction about the axis of rotation.

In this case, the stator is deformable in such a way that the stator surface has a non-circular surface profile in the circumferential direction about the axis of rotation without any magnetic interactions between the rotor and the stator being exerted (within at least one stator segment). In addition, the stator is deformable in such a way that, in the event that magnetic interactions between the rotor and the stator are exerted, the stator is deformed in such a way that the stator surface is circular in the circumferential direction about the axis of rotation, with the result that a spacing between the stator surface and the rotor surface is substantially constant.

The electric machine is, for example, an electric motor or an electric generator. In particular, the electric machine is a generator for a wind turbine. In modern wind turbines, transmissionless technologies are often used. The wind blades of the wind turbine in this case drive the rotor of the generator directly. Since no transmission is interposed between the rotor and the wind blades and the speed of the rotor is correspondingly low, the rotor and the stator have a large diameter. The diameter of the stator can be between 3.5 m and 4.5 m [meters], for example.

The rotor is, for example, an external rotor and may surround the stator. In another exemplary embodiment, the rotor is an internal rotor, with the result that the stator surrounds the rotor.

The rotor has, for example, permanent magnets which may be arranged next to one another in a row in the circumferential direction and which may have different polarization alternately, for example.

The stator may have, for example, a multiplicity of stator coils, which can be arranged on the stator surface. For this purpose, the stator may have, for example, a multiplicity of channels, which extend at least with a component parallel to the axis of rotation. The channels can act as cooling channels or the channels can be designed for accommodating corresponding stator coils.

The stator can be produced from an integral circular segment or from a multiplicity of stator segments, which are fastened to one another (for example detachably) successively in the circumferential direction.

Owing to the arrangement of the coils and the permanent magnets, high levels of magnetic interaction can prevail between the stator and the rotor. In particular during operation of the electric machine, for example, the magnetic interaction may be controlled by means of the stator coils in such a way that a magnetic tensile force, so to speak, acts circumferentially around the stator surface.

This magnetic interaction may result in a stator being deformed and, for example, being attracted in the direction of the rotor or repelled away from the rotor. The magnetic interactions between the rotor and the stator may be brought about, for example, by permanent magnets, which are arranged on the rotor and/or on the stator. The magnetic interactions can therefore take effect during operation or when the electric machine is at a standstill.

These magnetic interactions can be predetermined empirically or on the basis of laboratory tests, for example, for specific operating states, for example standstill or full load, of the electric machine. Depending on the knowledge of the intensity and the local characteristic of the magnetic interactions, the degree of deformation of the stator can be predetermined.

On the basis of this, the stator or its stator segments may be produced in such a way that the stator does not have a circular surface profile without magnetic interactions between the rotor and the stator being exerted, for example prior to fitting of the permanent magnets on the rotor. For example, the stator may have a flattened surface profile (in comparison to a circular characteristic) without magnetic interactions being exerted.

The deformability of the stator may be predeterminable in such a way that, on the basis of the predictable magnetic interactions between the rotor and the stator during operation of the generator or when the generator is at a standstill, the stator may be deformed in such a way that, in the event that the magnetic interaction is exerted, the stator has a circular surface profile.

The deformability of the stator can be dependent, for example, on the choice of materials, the wall thickness or the profile thickness and on the geometric dimensions, such as, for example, the diameter of the stator.

The stator may be provided with a laminated design, wherein a multiplicity of stator laminations are arranged one behind the other along the axial direction. Owing to this laminated design of the stator, said stator may have less rigidity than the rotor, for example. The deformability of the stator with a laminated design may likewise be predeterminable.

The stator surface is that surface of the stator which faces the rotor. Correspondingly, the rotor surface is that surface of the rotor which faces the stator. A gap is formed between the stator surface and the rotor surface. The gap or the radial spacing between the stator surface and the rotor surface may be constant owing to the deformation of the stator during operation of the electric machine. When the electric machine is out of operation, the stator may be deformed, i.e. without any magnetic interactions between the rotor and the stator being exerted, and the gap may be inconstant owing to the original non-circular configuration of the stator. The gap between the rotor surface and the stator surface may be approximately 2 mm up to approximately 8 mm [millimeters] in the radial direction during operation of the electric machine, i.e. when the magnetic interactions between the rotor and the stator are being exerted.

In accordance with a further aspect of the described embodiments, a method for producing an electric machine, in particular for producing a generator for a wind turbine, is described. The electric machine may have substantially the same features as the above-described electric machine. In accordance with the production method, the rotor is arranged rotatably relative to the stator. In addition, in accordance with the production method, the stator may be deformable in such a way that the stator surface may have a non-circular surface profile in the circumferential direction about the axis of rotation without any magnetic interactions between the rotor and the stator being exerted and that, in the event that magnetic interactions between the rotor and the stator are exerted, the stator may be deformed in such a way that the stator surface may be circular in the circumferential direction about the axis of rotation, with the result that a spacing between the stator surface and the rotor surface is substantially constant.

In addition, in accordance with an exemplary embodiment, a multiplicity of permanent magnets can be arranged on the rotor in order to generate the magnetic interactions between the rotor and the stator. In accordance with a further exemplary embodiment of the method, the arrangement of the permanent magnets on the rotor may be performed after the rotor has been arranged rotatably relative to the stator.

In accordance with described embodiments, the stator may be produced with a stator surface which has an uneven (corrugated) surface along the axial direction (i.e. along the axis of rotation of the rotor) and/or does not have a circular surface contour along the circumferential direction without any action of magnetic interactions between the rotor and the stator. Once magnetic interactions between the rotor and the stator have been exerted, for example during operation of the electric machine or else when the electric machine is at a standstill, the stator may be deformed in such a way that the stator surface has an even surface profile along the axial direction and a circular surface profile along the circumferential direction. Thus, during operation of the electric machine, or during the exertion of magnetic interactions between the rotor and the stator, a gap may be formed between the rotor and the stator, wherein the gap between the entire stator surface and the entire rotor surface is constant.

Owing to a formation of a substantially constant space between the rotor and the stator, the efficiency of the electric machine may be increased. In addition, the stator can be designed to be less rigid and more flexible since its deformation during the exertion of magnetic interactions may be predeterminable and may therefore be planned for in order to produce a substantially constant spacing between the rotor surface and the stator surface. In order to produce the stator such that it may be less rigid and may be flexible, less material may be used, with the result that production costs and the weight of the electric machine can be reduced.

Mention will be made of the fact that embodiments have been described with reference to different subject matters. In particular, embodiments are described by way of structure and function. However, on reading this application it will be immediately clear to a person skilled in the art that, where no explicit mention is made otherwise, in addition to a combination of features relating to different subject matters, any desired combination of features which belong to different structural and/or functional features is also possible.

### BRIEF DESCRIPTION

Some of the embodiments will be described in detail, with reference to the following figures, wherein like designations denote like members, wherein:

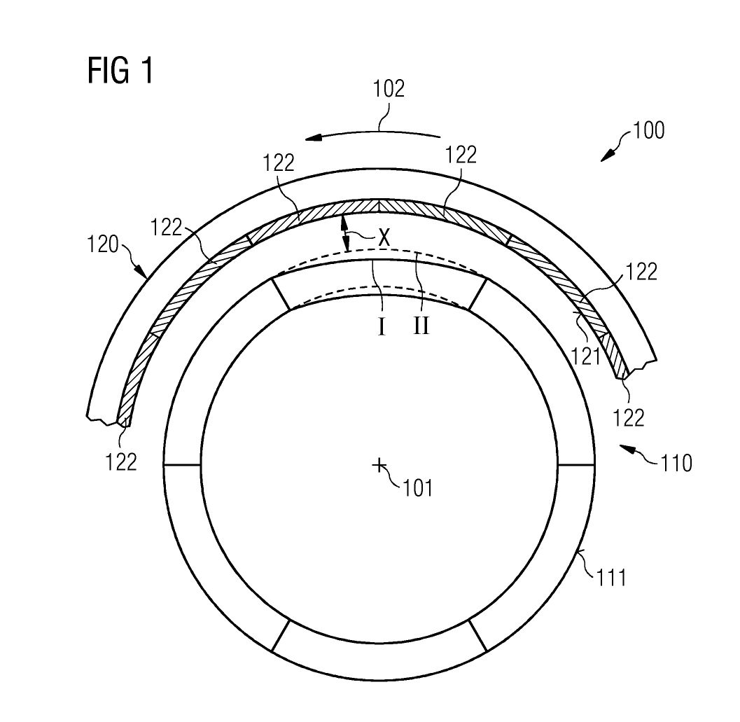

FIG. 1 shows a schematic illustration of an electric machine in accordance with an exemplary embodiment; and

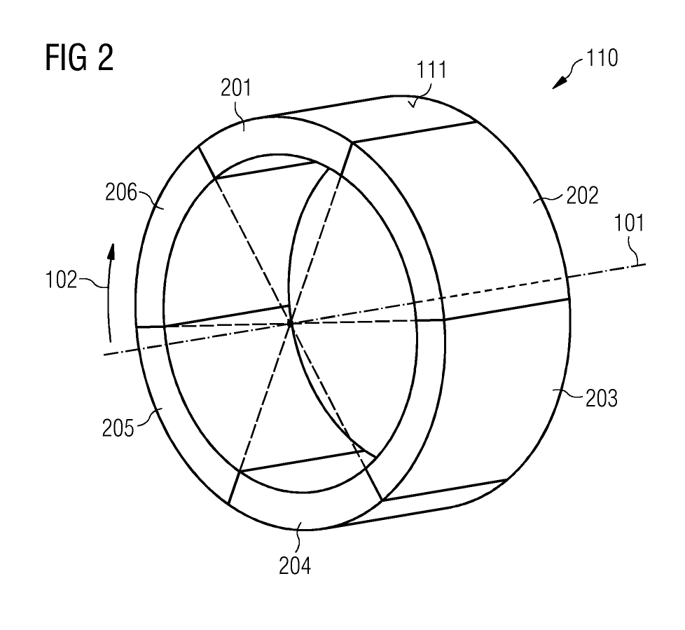

FIG. 2 shows a perspective illustration of a stator in accordance with an exemplary embodiment.

### DETAILED DESCRIPTION

Identical or similar components have been provided with the same reference numerals in the figures. The illustrations in the figures are schematic and may not be true to scale.

FIG. 1 shows an electric machine 100, which is a generator for a wind turbine, for example. The electric machine 100 has a rotor 120 and a stator 110. The exemplary embodiment in FIG. 1 has, for example, an external rotor 120, which surrounds the stator 110. For improved clarity, the rotor 120 is only illustrated sectionally.

The rotor 120 is arranged rotatably relative to the stator 110 about an axis of rotation 101. The rotor 120 and the stator 110 are arranged in such a way that a stator surface 111 of the stator and a rotor surface 121 of the rotor are spaced apart from one another. The stator surface 111 of the stator 110 is that surface of the stator which faces the rotor 120. The rotor surface 121 of the rotor 120 is that surface of the rotor 120 which faces the stator surface 111.

The rotor 120 may be rigid and substantially undeformable, with the result that the rotor surface 121 may be circular in the circumferential direction 102 about the axis of rotation 101 and may not be capable of being influenced by magnetic forces.

The stator 110 may be deformable in such a way that the stator surface 111 has a non-circular surface profile (corresponding to the continuous lines in FIG. 1) in the circumferential direction 102 about the axis of rotation 101 without any significant magnetic interactions between the rotor 120 and the stator 110 being exerted. In addition, the stator 110 may be deformable in such a way that, in the event that magnetic interactions between the rotor 120 and the stator 110 are exerted, the stator 110 may be deformable in such a way that the stator surface 111 may be at least substantially circular in the circumferential direction 102 about the axis of rotation 101, with the result that a spacing x between the stator surface 111 and the rotor surface 121 may be constant or substantially constant (dashed line in FIG. 1).

The stator 110 may be produced in such a way that, without the magnetic interactions, the stator 110 does not have a circular surface shape and has a flattened surface shape, corresponding to the operating state I.

Only once the magnetic interactions between the rotor 120 and the stator 110 have been exerted may the stator be deformed in such a way that the stator 110 or its stator surface 111 may have a circular or substantially circular surface profile shape (corresponding to operating state II).

The spacing x, which represents a radial spacing x with respect to the axis of rotation 101, may be constant or substantially constant in the operating state II, in which magnetic interactions between the rotor 120 and the stator 110 are exerted.

A multiplicity of permanent magnets 122 can be arranged on a surface of the rotor 120, in particular on the rotor surface 121.

In addition, the stator 110 may be deformable in such a way that the stator surface 111 may have an uneven surface profile (for example a corrugated surface profile, depending on the intensity and formation of the magnetic interactions between the rotor 120 and the stator 110) in the axial direction with respect to the axis of rotation 101 without any significant magnetic interactions between the rotor 120 and the stator 110 being exerted within at least one segment of the stator 110, and that, in the event that significant magnetic interactions between the rotor 120 and the rotor 110 are exerted, the stator 110 may be deformed in such a way that the stator surface 111 may have a smooth or substantially smooth (constant, i.e. smooth-non-corrugated, even) surface profile in the axial direction with respect to the axis of rotation 101, with the result that the spacing x between the stator surface 111 and the rotor surface 121 may be constant or substantially constant in the circumferential direction 102 and additionally in the axial direction.

FIG. 2 shows a perspective illustration of the stator 110. The stator 110 can be formed, for example, from a multiplicity of stator segments 201 to 206, which may be arranged next to one another in a circumferential direction 102. Each of the stator segments 201 to 206 can have, correspondingly, a non-circular shape or a non-circular surface profile along the circumferential direction 102 and/or an uneven surface profile along the axial direction with respect to the axis of rotation 101. Each stator segment 201 to 206 can have, independently of one another and individually, a predetermined deformation response, with the result that the stator 110 can be matched, along the circumferential direction 102, to different local magnetic interactions between the rotor 120 and the stator 110, with the result that, in the operating state II with magnetic interactions, each stator segment 201 to 206 may have a circular, smooth surface profile. Thus, during operation of the electric machine 100 in the operating state II, a constant and/or substantially constant spacing x between the rotor 120 and the stator 110 can be provided.

In addition it should be mentioned that “comprising” does not exclude any other elements or steps and “a” or “an” does not exclude the possibility of a plurality. In addition, it should be noted that features or steps which have been described with reference to one of the above exemplary embodiments can also be used in combination with other features or steps of other above-described exemplary embodiments. Reference symbols in the claims should not be regarded as a restriction.

1. An electric machine, in particular a generator for a wind turbine, said electric machine comprising:
a rotor, and
a stator,
wherein the rotor is arranged rotatably about an axis of rotation relative to the stator,
wherein the rotor and the stator are arranged in such a way that a stator surface of the stator and a rotor surface of the rotor are spaced apart from one another,
wherein the rotor surface is circular in the circumferential direction about the axis of rotation,
wherein the stator is deformable such
that the stator surface has a non-circular surface profile in the circumferential direction about the axis of rotation without any magnetic interactions being exerted between the rotor and the stator within at least one segment of the stator, and
that, in the event that magnetic interactions are exerted between the rotor and the stator, the stator is deformed in such a way that the stator surface is circular in the circumferential direction about the axis of rotation, with the result that a spacing between the stator surface and the rotor surface is constant.

2. The electric machine as claimed in claim 1,
wherein the stator is deformable in such a way
that the stator surface has an uneven surface profile in the axial direction with respect to the axis of rotation without magnetic interactions between the rotor and the stator being exerted within at least one segment of the stator, and
that, in the event that magnetic interactions between the rotor and the stator are exerted, the stator is deformed in such a way that the stator surface has a smooth surface profile in the axial direction with respect to the axis of rotation, with the result that a spacing between the stator surface and the rotor surface is constant.

3. The electric machine as claimed in claim 1,
wherein the rotor is an external rotor and surrounds the stator.

4. The electric machine as claimed in claim 1,
wherein the rotor is an internal rotor and the stator surrounds the rotor.

5. The electric machine as claimed in claim 1,
wherein the rotor has at least one permanent magnet for generating the magnetic interactions between the rotor and the stator.

6. The electric machine as claimed in claim 1,
wherein the stator has a multiplicity of channels, which extend with at least one component along the axis of rotation.

7. The electric machine as claimed in claim 6,
wherein the stator has at least one stator coil, which is arranged in one of the channels.

8. The electric machine as claimed in claim 1,
wherein the stator consists of a multiplicity of stator segments, which are fastened to one another successively in the circumferential direction.

9. A method for producing an electric machine, in particular for producing a generator for a wind turbine, said method comprising:
arranging a rotor rotatably relative to a stator about an axis of rotation,
wherein the rotor and a stator are arranged in such a way that a stator surface of the stator and a rotor surface of the rotor are spaced apart from one another,
wherein the rotor surface is circular in the circumferential direction about the axis of rotation, and
forming a stator so as to be deformable in such a way
that the stator surface has a non-circular surface profile in the circumferential direction about the axis of rotation without any magnetic interactions between the rotor and the stator being exerted, and
that, in the event that magnetic interactions between the rotor and the stator are exerted, the stator is deformed in such a way that the stator surface is circular in the circumferential direction about the axis of rotation, with the result that a spacing between the stator surface and the rotor surface is constant.

10. The method as claimed in claim 9, further comprising
arranging permanent magnets on the rotor in order to generate the magnetic interactions between the rotor and the stator.

11. The method as claimed in claim 10,
wherein the arrangement of the permanent magnets on the rotor is performed after the rotor has been arranged rotatably relative to the stator.
